(19) United States
(12) Patent Application Publication
(10) Pub. No.: US 2025/0305949 A1
(43) Pub. Date: Oct. 2, 2025

(54) WAVELENGTH-SCANNING-BASED LENSLESS FOURIER PTYCHOGRAPHIC DIFFRACTION TOMOGRAPHY MICROSCOPY METHOD

(71) Applicant: Nanjing University of Science and Technology, Nanjing, Jiangsu (CN)

(72) Inventors: Chao ZUO, Nanjing (CN); Qian CHEN, Nanjing (CN); Jiasong SUN, Nanjing (CN); Shijie FENG, Nanjing (CN); Xuejuan WU, Nanjing (CN); Yao FAN, Nanjing (CN); Linpeng LU, Nanjing (CN); Yuzhen ZHANG, Nanjing (CN)

(73) Assignee: Nanjing University of Science and Technology, Nanjing, Jiangsu (CN)

(21) Appl. No.: 18/864,133

(22) PCT Filed: Apr. 27, 2023
(86) PCT No.: PCT/CN2023/091011

§ 371 Date: Nov. 8, 2024

(30) Foreign Application Priority Data
Jul. 19, 2022 (CN) 202210847769.1

(51) Int. Cl. G01N 21/41; G06F 17/14

(52) U.S. Cl. CPC G01N 21/41; G06F 17/14

(57) ABSTRACT

The invention presents a lensless Fourier ptychographic diffraction tomography microscopy imaging method based on wavelength scanning. The technique uses only a wavelength-tunable light source for illumination on a lensless microscope experimental system to collect a series of coaxial holograms. Then, the three-dimensional scattering potential spectrum is filled using an iterative Fourier ptychographic method to restore the three-dimensional refractive index distribution of the sample directly. The present invention does not require complex modifications to traditional lensless on-chip microscopes. It can endow lensless on-chip microscopes with the ability of pixel super-resolution three-dimensional tomographic imaging.

### TECHNICAL FIELD

The present invention belongs to three-dimensional refractive index imaging technology, specifically a lensless Fourier ptychographic diffraction tomography microscopy imaging method based on wavelength scanning.

### BACKGROUND

High-throughput microscopy imaging, i.e., the technique of capturing images over a large field of view without compromising spatial and temporal resolution, is critical to imaging science in applications such as neuroscience, stem cell biology, developmental biology, early cancer diagnosis, and drug screening. We need to perform high-content quantitative analysis of multiple events in large cell populations. However, the amount of information that traditional microscopy imaging systems can provide is always limited by the Space bandwidth product (SBP), typically in the tens of millions of pixels. More specifically, traditional microscopes face a trade-off between resolution and field of view size. At low magnification, the field of view is large but the resolution is low; although the resolution is improved by switching to a high magnification mirror, the field of view is correspondingly reduced by a higher proportion. Recently developed computational optical microscopy technologies include lensless on-chip holographic microscopy imaging, Fourier ptychographic microscopy imaging, and synthetic aperture holographic microscopy. Among these methods, lensless super-resolved microscopy is the most promising technology for development. It achieves a large effective numerical aperture (NA) close to one in the native field of view of the imaging sensor without the need for lenses or other intermediate optical components. This further simplifies the imaging setup while effectively avoiding the inherent optical aberrations and chromatic problems of traditional lens-based imaging systems. In addition, the entire system can be miniaturized and manufactured at low cost, providing a potential solution for point-of-care medical diagnosis in resource-limited environments to reduce medical costs.

Although the lensless on-chip holographic microscopy imaging technology seems to effectively solve the spatial bandwidth product limitation of traditional microscopy imaging systems, there are still many problems that limit its practical application. First, because the sample is placed close to the sensor surface, the imaging resolution is limited by the pixel size of the imaging device. Due to limitations in technology and manufacturing processes, the resolution of current sensors is still far below the optical diffraction limit. Therefore, a large amount of research in this field has focused on “pixel super-resolution”, and many methods have been proposed, such as two-dimensional lateral sub-pixel scanning of sensors, sub-pixel scanning of light source micro-displacement, axial multi-defocus distance scanning of sensors, wavelength scanning of illumination light, etc., to achieve detection with super-pixel resolution of more than twice. Second, label-free microscopy is the most ideal detection method for studying the dynamic processes and physiological activities of living cells. Many quantitative phase imaging techniques based on lensless on-chip microscopy have been developed. For example, we have achieved long-term observation of living cells using active plate scanning and multi-wavelength scanning methods. Finally, the lensless microscopy methods for both intensity measurement and phase recovery are aimed at imaging two-dimensional thin samples and lack three-dimensional tomographic capabilities. To date, only a few studies have investigated lensless imaging of three-dimensional thick samples. Isikman et al. combined the basic concept of lensless holographic microscopy with multi-angle illumination (Isikman S O, Bishara W, Mavandadi S, et al. Lens-free optical tomographic microscope with a large imaging volume on a chip[J]. Proceedings of the National Academy of Sciences, 2011, 108(18): 7296-7301.). The volume image of the object was reconstructed using the filtered back projection (FBP) algorithm. FBP ignores the diffraction information of the object and is therefore unable to image phase objects. In addition, the use of robotic anns makes the experimental setup complex and expensive. Zuo et al. used LED array to contruct an experimental system without mechanical displacement (Zuo C, Sun J, Zhang J, et al. Lensless phase microscopy and diffraction tomography with multi-angle and multi-wavelength illuminations using a LED matrix[J]. Optics express, 2015, 23(11): 14314-14328.), solving this problem by using optical diffraction tomography instead of filtered back projection in the error reconstruction process, and implementing multi-wavelength light sources at each illumination angle to recover the phase of the hologram. Recovering the refractive index distribution of a three-dimensional object from a hologram sequence is essentially an inverse scattering problem. Berdeu et al. established a lensless on-chip diffraction tomography platform using a 360° axially rotating robotic arm equipped with a fixed 45° tilt angle light source (Berdeu A, Momey F, Laperrousaz B, et al. Comparative study of fully three-dimensional reconstruction algorithms for lens-free microscopy[J]. Applied optics, 2017, 56(13): 3939-3951.). They calculate the complex amplitude of each illumination angle using phase slope or two-dimensional phase retrieval methods, taking diffraction effects into account. A full three-dimensional reconstruction is then obtained based on the Fourier diffraction theorem. The above methods all use experimental platforms based on multi-angle illumination. However, in lensless imaging, the objects are all defocused. As the angle of illumination changes, the imaging position of the sample changes by tens or even hundreds of microns. This means that the effective field of view in multi-angle illumination methods is much smaller than the size of the sensor target area. In addition, the movement of objects can also cause difficulties in image registration. For these reasons, the results of lensless 3D imaging are not ideal, and the resolution is still limited by the discrete sampling of the sensor.

### SUMMARY OF THE INVENTION

The purpose of the present invention is to provide a lensless Fourier ptychographic diffraction tomography microscopy imaging method based on wavelength scanning.

The technical solution for achieving the purpose of the present invention is a wavelength-scanning-based lensless Fourier ptychographic diffraction tomography microscopy method, with the following steps:
Step 1: Collect the original intensity images;
Step 2: Construct the three-dimensional refractive index space of the object;
Step 3: Determine the corresponding position of the hologram collected at the corresponding wavelength on the 3D spectrum, and obtain the new refractive index distribution of the sample;
Step 4: Based on the new refractive index distribution of the sample, repeat Step 3 to complete the 3D spectrum iteration at the next wavelength and obtain the final refractive index distribution of the sample.

The raw intensity images are collected using a lensless on-chip microscopy system, which includes a wavelength-scanning illumination source and a sensor. The wavelength-scanning illumination source is a combination of a supercontinuum laser and an acousto-optic tunable filter, or a wavelength-multiplexed source composed of multiple monochromatic laser sources or a wavelength-scanning laser. When the wavelength-scanning illumination source is a combination of a supercontinuum laser and an acousto-optic tunable filter, the broadband beam emitted by the supercontinuum laser is filtered by the acousto-optic tunable filter and irradiated on the sample on the sensor surface.

The effective pixelsize of the 3D refractive index space n(r) of the object meets the final imaging resolution, and the number of pixels Nₓ, N_{y}, N_{z} in the 3D matrix satisfies the minimum sampling number in each direction.

The specific steps for determining the corresponding positions of holograms collected at different wavelengths on the three-dimensional spectrum are as follows:
Step 3.1, calculate the scattering potential of the sample at the corresponding wavelength, the formula is:

$$V ( r , ω ) = {k}_{0}^{2} ( ω ) [ {n}^{2} ( r ) - {n}_{m}^{2} ]$$

where V(r, ω) is the scattering potential, r=(rₓ, r_{y}, r_{z}) is the spatial coordinates, ω=2πc/λ is the angular frequency, c is the speed of light in vacuum,

$${k}_{0} ( ω ) = \frac{2 π}{λ}$$

represents the wave number in vacuum, n(r) is the refractive index distribution of the sample, and nₘ is the refractive index of the background medium:
Step 3.2, perform a three-dimensional Fourier transform on the scattering potential V(r,ω) of the sample to obtain a three-dimensional Fourier spectrum \hat{V}(u, ω), where u=(uₓ, u_{y}, u_{z}) is the spatial frequency coordinate;
Project the three-dimensional sub spectrum along the u_{z} direction to obtain the two-dimensional sub spectrum \hat{V}(u_{T}, ω). The formula is as follows:

$$\hat{V} ( {u}_{T} , ω ) = \frac{j}{4 π {u}_{z}} \hat{V} [ u - {k}_{m} ( ω ) , ω ] δ ( {u}_{z} - \sqrt{{k}_{m}^{2} ( ω ) - {\vert {u}_{T} \vert}^{2}} )$$

where u_{T}=(uₓ,u_{y}) represents the two-dimensional spatial frequency coordinate; kₘ(ω) is the wave vector in the surrounding medium, kₘ(ω)=|kₘ(ω)|=k₀(ω)nₘ is the wave number in the surrounding medium, k₀(ω)nₘ is the radius of the three-dimensional sub spectrum, and δ(·) is the Dirac function;
Step 3.3, perform inverse Fourier transform on the two-dimensional sub-spectrum to obtain the normalized first-order scattering field complex amplitude Uₛᵢₙ(r_{T}, ω) on the focal plane; Using Rytov approximation, the complex amplitude on the focus plane is obtained based on the normalized first-order scattering field complex amplitude on the focus plane;
Step 3.4, use the angular spectrum method to propagate the complex amplitude on the focus plane to the sensor plane, obtaining the complex amplitude U(r_{T}, ω) of the sensor plane, and update the amplitude using the square root of the intensity I(r_{T}, ω). Then propagate the updated complex amplitude to the focal plane to obtain the updated complex amplitude Ūₛ₁(r_{T}, ω) of the scattering field on the focal plane;
Step 3.5, perform ln(·) operation on the complex amplitude Ūₛ₁(r_{T}, ω) to obtain the updated normalized first-order scattering field Ūₛᵢₙ(r_{T},ω)=ln[Ūₛ₁(r_{T},ω)]. Perform Fourier transform on Ūₛᵢₙ(r_{T},ω) to obtain the updated two-dimensional spectrum [symbol] (u_{T}, ω); Remap [symbol] (u_{T}, ω) into an Ewald shell and insert it into the corresponding position of the original three-dimensional spectrum \hat{V}(u, ω). After performing a three-dimensional inverse Fourier transform on the updated three-dimensional spectrum \overline{\hat{V}}(u_{T},ω), the updated refractive index distribution n̅(r) of the sample is obtained. The specific formula for amplitude update using the square root of intensity I(r_{T}, ω) is:

$$\overline{U} ( {r}_{T} , ω ) = \sqrt{I ( {r}_{T} , ω )} \cdot exp \{ j \cdot arg [ U ( {r}_{T} , ω ) ] \}$$

Where j is the imaginary unit, arg(·) is the function to obtain the argument.

Compared with the existing technology, the present invention has significant advantages: (1) the present invention can achieve uniform resolution pixel super-resolution three-dimensional imaging in the entire field of view of the sensor; (2) the present invention has only one light source in a fixed position, which can maintain relatively high coherence and does not introduce mechanical displacement, thereby improving stability.

The present invention will be further described in detail regarding the accompanying drawings.

### ATTACHED IMAGE DESCRIPTION

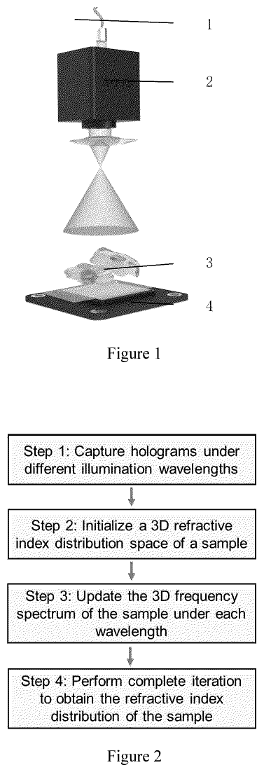

FIG. 1 is a schematic diagram of a wavelength-scanning-based tomography experimental setup based on lensless on-chip microscopy.

FIG. 2 is a flowchart of the large field pixel super-resolution lensless Fourier ptychographic diffraction tomography microscopy method based on wavelength scanning.

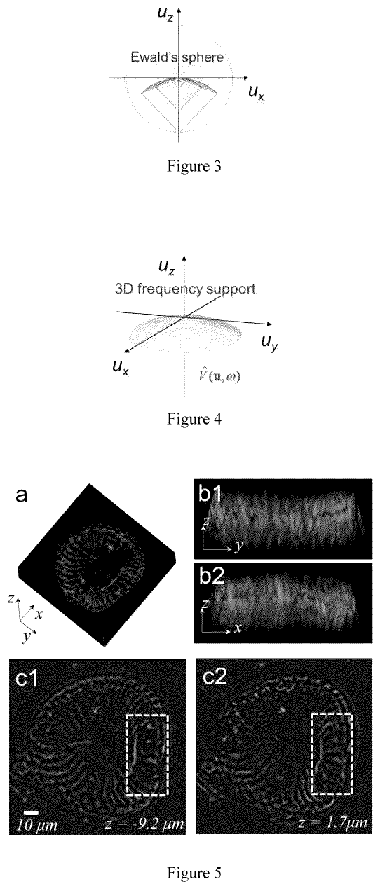

FIG. 3 shows the corresponding positions of holograms collected at different wavelengths on the three-dimensional spectrum.

FIG. 4 is a schematic diagram of the spectral shape corresponding to the refractive index distribution of the final reconstructed sample.

FIG. 5 shows the rendered three-dimensional refractive index distribution of a single diatom reconstructed using this method, as well as the two-dimensional refractive index distribution at different z-axis depths.

### SPECIFIC IMPLEMENTATION METHOD

In FIG. 2, a wavelength-scanning-based lensless Fourier ptychographic diffraction tomography method, including 4 steps:
Step 1: Collect the original intensity images;

In FIG. 1, the invention is based on a traditional lensless on-chip microscopy system, which includes a wavelength-scanning illumination source, a sample 3 and a sensor 4. The wavelength-scanning illumination source is a combination of a supercontinuum laser 1 (YSL SC-Pro7) and an acousto-optic tunable filter 2 (AOTF, YSL AOTF-Pro, bandwidth: 2-11 nm, RF1: 430-780 nm, RF2: 780-1450 nm). The wavelength-scanning range is 430-1450 nm with the interval of 1 nm. In addition, multiple monochromatic light sources (lasers, LEDs) can be coupled or wavelength scanning lasers can be used instead of the combination of supercontinuum lasers and acousto-optic filters to achieve wavelength scanning. The sample 3 is directly placed on the image sensor for imaging, and this system uses a board level monochrome CMOS sensor 4 (1.67 microns, 3872×2764, The Imaging Source DMX 24UJ003) for capture.

The specific implementation process is as follows: using a coherent light source with a wide range of tunable wavelengths, sequentially tuning the illumination wavelength {Δ′, i=1, 2, . . . , N}, illuminating the sample, and synchronously triggering the camera to record holographic image sequences at different wavelengths, denoted {Iₑₓₚ(r_{T},ω), ω=ω¹, ω², . . . , ω^{N}}.
Step 2: Construct the three-dimensional refractive index space of the object;

The specific implementation process is as follows: assuming that the refractive index of the background medium is a constant, its refractive index is nₘ. Construct a high-resolution three-dimensional refractive index space n(r) with a large field of view for the object. The pixel size of the three-dimensional refractive index space must meet the final imaging resolution, and the number of pixels Nₓ, N_{y}, N_{z} in the three-dimensional matrix must meet the minimum sampling number in each direction.
Step 3: Determine the corresponding position of the hologram collected at the corresponding wavelength on the 3D spectrum, and obtain the new refractive index distribution of the sample; The specific implementation process is as follows:
Step 3.1, calculate the scattering potential of the sample at the corresponding wavelength, the formula is:

$$V ( r , ω ) = {k}_{0}^{2} ( ω ) [ {n}^{2} ( r ) - {n}_{m}^{2} ]$$

where V(r, ω) is the scattering potential, r=(rₓ, r_{y}, r_{z}) is the spatial coordinates, ω=2πc/λ is the angular frequency, c is the speed of light in vacuum,

$${k}_{0} ( ω ) = \frac{2 π}{λ}$$

represents the wave number in vacuum, n(r) is the refractive index distribution of the sample, and nₘ is the refractive index of the background medium;
Step 3.2, perform a three-dimensional Fourier transform on the scattering potential V(r,ω) of the sample to obtain a three-dimensional Fourier spectrum \hat{V}(u, ω), where u=(uₓ, u_{y}, u_{z}) is the spatial frequency coordinate;
Project the three-dimensional sub spectrum along the u_{z} direction to obtain the two-dimensional sub spectrum \hat{V}(u_{T},ω). The formula is as follows:

$$\hat{V} ( {u}_{T} , ω ) = \frac{j}{4 π {u}_{z}} \hat{V} [ u - {k}_{m} ( ω ) , ω ] δ ( {u}_{z} - \sqrt{{k}_{m}^{2} ( ω ) - {\vert {u}_{T} \vert}^{2}} )$$

where u_{T}=(uₓ,u_{y}) represents the two-dimensional spatial frequency coordinate; kₘ(ω) is the wave vector in the surrounding medium, kₘ(ω)=|kₘ(ω)|=k₀(ω)nₘ is the wave number in the surrounding medium, k₀(ω)nₘ is the radius of the three-dimensional sub spectrum, and δ(·) is the Dirac function;
Step 3.3, perform inverse Fourier transform on the two-dimensional sub-spectrum to obtain the normalized first-order scattering field complex amplitude Uₛᵢₙ(r_{T},ω) on the focal plane: Using Rytov approximation, the complex amplitude on the focus plane is obtained based on the normalized first-order scattering field complex amplitude on the focus plane;
Step 3.4, use the angular spectrum method to propagate the complex amplitude on the focus plane to the sensor plane, obtaining the complex amplitude U(r_{T}, ω) of the sensor plane, and update the amplitude using the square root of the intensity I(r_{T}, ω). Then propagate the updated complex amplitude to the focal plane to obtain the updated complex amplitude Ūₛ₁(r_{T}, ω) of the scattering field on the focal plane;
Step 3.5, perform ln(·) operation on the complex amplitude Ūₛ₁(r_{T},ω) to obtain the updated normalized first-order scattering field Ūₛᵢₙ(r_{T},ω)=ln[Ūₛ₁(r_{T},ω)]. Perform Fourier transform on Ūₛᵢₙ(r_{T}, ω) to obtain the updated two-dimensional spectrum [symbol] (u_{T}, ω); Remap [symbol] (u_{T}, ω) into an Ewald shell and insert it into the corresponding position of the original three-dimensional spectrum \hat{V}(u, ω). After performing a three-dimensional inverse Fourier transform on the updated three-dimensional spectrum [symbol] (u, ω), the updated refractive index distribution n̅(r) of the sample is obtained. This completes a sub iteration of the lensless diffraction tomography algorithm based on wavelength scanning.
Step 4: Perform a complete iteration of the tested object to obtain the refractive index distribution n(r) of the sample.

Update the new refractive index distribution n̅(r) obtained in steps 3.5 to 3.1, calculate the corresponding position of the hologram collected at another wavelength on the three-dimensional spectrum, and obtain the new refractive index distribution of the sample. Repeat step 3 multiple times to obtain the converged result. FIG. 4 shows the range covered by the Ewald sphere in three-dimensional frequency domain space under multi-wavelength illumination. FIG. 5 shows the rendered three-dimensional refractive index distribution of a single diatom reconstructed using this method, as well as the two-dimensional refractive index distribution at different z-axis depths.

The present invention only requires obtaining a series of holograms by tuning the illumination wavelength under vertical illumination of the light source, and then gradually combining these intensity images into the three-dimensional refractive index distribution of the sample using a multi-wavelength Fourier ptychographic diffraction tomography reconstruction algorithm combined with a propagation model. The present invention has only one light source in a fixed position, which can maintain relatively high coherence and does not introduce mechanical displacement, thereby improving the stability of the system.

1. A wavelength-scanning-based lensless Fourier ptychographic diffraction tomography method, characterized by the following steps:
Step 1: Collect the original intensity images;
Step 2: Construct the three-dimensional refractive index space of the object;
Step 3: Determine the corresponding position of the hologram collected at the corresponding wavelength on the 3D spectrum, and obtain the new refractive index distribution of the sample;
Step 4: Based on the new refractive index distribution of the sample, repeat Step 3 to complete the 3D spectrum iteration at the next wavelength and obtain the final refractive index distribution of the sample.

2. The wavelength-scanning-based lensless Fourier ptychographic diffraction tomography microscopy method according to claim 1, wherein the raw intensity images are collected using a lensless on-chip microscopy system, which includes a wavelength-scanning illumination source and a sensor; the wavelength-scanning illumination source is a combination of a supercontinuum laser and an acousto-optic tunable filter, or a wavelength-multiplexed source composed of multiple monochromatic laser sources or a wavelength-scanning laser; when the wavelength-scanning illumination source is a combination of a supercontinuum laser and an acousto-optic tunable filter, the broadband beam emitted by the supercontinuum laser is filtered by the acousto-optic tunable filter and irradiated on the sample on the sensor surface.

3. The wavelength-scanning-based lensless Fourier ptychographic diffraction tomography microscopy method according to claim 1, wherein the effective pixelsize of the 3D refractive index space n(r) of the object meets the final imaging resolution, and the number of pixels Nₓ, N_{y}, N_{z} in the 3D matrix satisfies the minimum sampling number in each direction.

4. The wavelength-scanning-based lensless Fourier ptychographic diffraction tomography microscopy method according to claim 1, wherein the specific steps for determining the corresponding positions of holograms collected at different wavelengths on the three-dimensional spectrum are as follows:
Step 3.1, calculate the scattering potential of the sample at the corresponding wavelength, the formula is:
$$V ( r , ω ) = {k}_{0}^{2} ( ω ) [ {n}^{2} ( r ) - {n}_{m}^{2} ]$$
where V(r, ω) is the scattering potential, r=(rₓ, r_{y}, r_{z}) is the spatial coordinates, ω=2πc/λ is the angular frequency, c is the speed of light in vacuum,
$${k}_{0} ( ω ) = \frac{2 π}{λ}$$
represents the wave number in vacuum, n(r) is the refractive index distribution of the sample, and nₘ is the refractive index of the background medium;
Step 3.2, perform a three-dimensional Fourier transform on the scattering potential V(r, ω) of the sample to obtain a three-dimensional Fourier spectrum \hat{V}(u, ω), where u=(uₓ, u_{y}, u_{z}) is the spatial frequency coordinate;
Project the three-dimensional sub-spectrum along the u_{z} direction to obtain the two-dimensional sub spectrum \hat{V}(u_{T}, ω); the formula is as follows:
$$\hat{V} ( {u}_{T} , ω ) = \frac{j}{4 π {u}_{z}} \hat{V} [ u - {k}_{m} ( ω ) , ω ] δ ( {u}_{z} - \sqrt{{k}_{m}^{2} ( ω ) - {\vert {u}_{T} \vert}^{2}} )$$
where u_{T}=(uₓ, u_{y}) represents the two-dimensional spatial frequency coordinate; kₘ(ω) is the wave vector in the surrounding medium, kₘ(ω)=|kₘ(ω)|=k₀(ω)nₘ is the wave number in the surrounding medium, k₀(ω)nₘ is the radius of the three-dimensional sub spectrum, and δ(·) is the Dirac function;
Step 3.3, perform inverse Fourier transform on the two-dimensional sub-spectrum to obtain the normalized first-order scattering field complex amplitude Uₛᵢₙ(r_{T}, ω) on the focal plane; Using Rytov approximation, the complex amplitude on the focus plane is obtained based on the normalized first-order scattering field complex amplitude on the focus plane;
Step 3.4, use the angular spectrum method to propagate the complex amplitude on the focus plane to the sensor plane, obtaining the complex amplitude U(r_{T}, ω) of the sensor plane, and update the amplitude using the square root of the intensity I(r_{T}, ω); then propagate the updated complex amplitude to the focal plane to obtain the updated complex amplitude Ūₛ₁(r_{T},ω) of the scattering field on the focal plane;
Step 3.5, perform ln(·) operation on the complex amplitude Ūₛ₁(r_{T},ω) to obtain the updated normalized first-order scattering field Ūₛᵢₙ(r_{T}, ω)=ln[Ūₛ₁(r_{T}, ω)]; perform Fourier transform on Ūₛᵢₙ (r_{T}, ω) to obtain the updated two-dimensional spectrum [symbol] (u_{T},ω); Remap [symbol] (u_{T}, ω) into an Ewald shell and insert it into the corresponding position of the original three-dimensional spectrum \hat{V}(u, ω); after performing a three-dimensional inverse Fourier transform on the updated three-dimensional spectrum [symbol] (u, ω), the updated refractive index distribution n̅(r) of the sample is obtained.

5. The wavelength-scanning-based lensless Fourier ptychographic diffraction tomography microscopy method according to claim 4, wherein the complex amplitude on the focus plane is
$${U}_{s 1} ( {r}_{T} , ω ) = {U}_{in} ( {r}_{T} , ω ) exp [ {U}_{s 1 n} ( {r}_{T} , ω ) ]$$
where Uₛ₁(r_{T}, ω) is the complex amplitude of the first-order scattering field.

6. The wavelength-scanning-based lensless Fourier ptychographic diffraction tomography microscopy method according to claim 4, wherein the specific formula for amplitude update using the square root of intensity I(r_{T}, ω) is:
$$\overline{U} ( {r}_{T} , ω ) = \sqrt{I ( {r}_{T} , ω )} \cdot exp \{ j \cdot arg [ U ( {r}_{T} , ω ) ] \}$$
Where j is the imaginary unit, arg(·) is the function to obtain the argument.
